(19) United States
(12) Patent Application Publication
(10) Pub. No.: US 2026/0124671 A1
(43) Pub. Date: May 7, 2026

(54) CASTING METHOD AND APPARATUS

(71) Applicant: Wuxi Cummins Turbo Technologies Company Ltd., Jiangsu (CN)

(72) Inventors: Tongjun GAO, Jiangsu (CN); Kaifeng WU, Jiangsu (CN)

(21) Appl. No.: 19/120,659

(22) PCT Filed: Oct. 13, 2022
(86) PCT No.: PCT/CN2022/125147

§ 371 Date: Apr. 11, 2025

(51) Int. Cl. B22C 3/00; B22C 9/10; F01D 25/24

(52) U.S. Cl. CPC B22C 3/00; B22C 9/10; F01D 25/24; F05D 2230/21; F05D 2230/90

(57) ABSTRACT

A mould element (such as mould core) for casting metal is made by a process that starts with a coated mould element having a coating (such as a core coating). The coated mould element is provided with a further coating and a bond coating on the further coating, the bond coating allowing the further coating to attach to a metal casting made with the mould element, such as a cast housing for a turbomachine.

### TECHNICAL FIELD

The present invention relates to a process of forming a mould element for casting metal, a method of casting a housing for a turbomachine, a mould element for use in casting metal, a mould for producing a casting, a housing for a turbomachine, and a casting or turbine housing manufactured according to the aforesaid process or method or utilising the aforesaid core or mould. The mould element is preferably, but not exclusively, a mould core, which may be simply referred to as a core. The present invention has particular, but not exclusive, application to the manufacture of turbomachine turbine housings which include one or more protective coatings.

### BACKGROUND OF THE INVENTION

Turbochargers are well-known devices for supplying air to the intake of an internal combustion engine at pressures above atmospheric pressure (boost pressure). A conventional turbocharger essentially comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the inlet manifold of the engine, thereby increasing engine power. The turbocharger shaft is conventionally supported by journal and thrust bearings, including appropriate lubricating systems, located within a central bearing housing connected between the turbine and compressor wheel housing.

In known turbochargers, the turbine stage comprises a turbine chamber within which the turbine wheel is mounted; an annular inlet passageway defined between facing radial walls arranged around the turbine chamber; an inlet volute arranged around the inlet passageway; and an outlet passageway extending from the turbine chamber. The passageways and chambers communicate such that pressurised exhaust gas admitted to the inlet volute flows through the inlet passageway to the outlet passageway via the turbine and rotates the turbine wheel.

Metal castings are commonly made by introducing liquid metal into a mould and then allowing the liquid metal to solidify. For metal castings which have a complicated shape, such as those which define a volute or cavity, it is often necessary to use a mould which includes a core. The core can be an intrinsic part of the mould or a separate piece. Various types of mould exist depending on the type of casting being undertaken. For example, for components which have thin walls, high pressure die casting may be used. In high-pressure die-casting, liquid metal is provided into a mould cavity under pressure where it is held until it has solidified sufficiently. The mould, also referred to as a die, is then opened to release the casting. This cycle can then be repeated to produce further castings. Another type of moulding is sand moulding where a mould and/or core are formed of sand which includes binder additives to allow the mould to retain the desired shape. A surface coating may be provided in order to reduce or prevent gases released from the breakdown of binder additives in the mould due to the high temperatures involved in metal casting from damaging the surface of the casting. For example, acidic gases may be released from the mould and these may cause damage to the surface of the casting. The casting may be released from a sand mould by breaking the sand mould and the casting may then be fettled to remove excess mould material and any casting irregularities after release from the mould. Housings for turbomachines can be made by casting in a sand mould.

After release from a mould, castings may require treatment to provide a protective coating on a surface thereof. Whilst this may be straightforward in cases where the casting is of a simple shape or where the casting can simply be dipped, it is much more difficult for castings which have complex shapes, particularly ones with internal surfaces. The additional difficulty in protecting complex shapes incurs additional costs and may still result in a less consistent protective coating being applied, which can lead to the protective coating detaching from the surface or otherwise failing.

CN111230048 describes methods for manufacturing cast components with integral thermal barrier coatings. This is achieved by providing a core coated with a thermal barrier coating, disposing the core within a casting mould, casting metal around at least a portion of the coated core to form a casting intermediary, and then removing the core from the casting intermediary to form a cast component. An outer metal layer may be applied to the thermal barrier coating.

The present invention has been provided to address at least some of the deficiencies of the prior art.

### SUMMARY

The present invention aims to provide new and useful methods and assemblies for use in the manufacture of castings, particularly housings for turbomachines, which include at least one functional layer, such as a protective or thermal barrier layer.

In general terms, the present invention proposes that a surface coating of a metal casting, such as a housing for a turbomachine, is provided via casting the metal casting in a mould which includes a bond coating that is configured to allow a further coating to attach to the casting, and a further coating that lies between the bond coating and a mould element coating, such as a core coating. In the mould, the bond coating is exposed to the cavity into which liquid metal is provided such that the bond coating is able to bond with the casting. On the other side of the bond coating, a further coating is provided. The further coating may be a functional coating, such as a protective coating or a thermally insulating coating. The further coating is disposed between the bond coating and the mould element coating such that after the casting process has been completed and the mould has been removed, the mould element and mould element coating are removed leaving the further coating as the surface finish of the casting. In this way, complex shapes can be readily and reliably provided with a coating, which is particularly advantageous when the shape includes an inner surface or volute which would otherwise be impossible to readily and reliably coat. The present invention not only allow for the provision of a functional coating as the surface finish of an internal portion of a casting, such as the interior of a volute, but also for the provision of a functional coating as the surface finish of an external portion of a casting.

As such, according to a first aspect of the present disclosure, there is provided a process of forming a mould element for casting metal, the process including: a) providing a coated central mould element; b) providing a further coating on the coated central mould element; and c) providing a bond coating on the further coating.

The mould element may be an integral portion of a mould which defines an interior shape of a casting, or may be a separate element to the mould. In other words, the mould element may be any one or more of a mould core, a cope, a drag, or any other element of a complete mould. By providing a coated central mould element, the ultimate surface of the casting, namely the further coating which is on the surface of the casting once it has been released from the mould, is free of defects as the liquid metal does not penetrate the mould and gases released from the mould are prevented from damaging the ultimate surface of the casting. The bond coating serves to provide bond the material of the casting to the further coating as otherwise the further coating is susceptible to becoming detached from the material of the casting, which can have obvious negative consequences if this happens in use. Without the bond coating, the surface coating is not properly attached to the metal of the casting, which renders it unsuitable for use, particularly where there is a risk of damage should the further coating detach from the rest of the metal casting. The order of the different coatings, namely the core coating, the further coating, and the bond coating, is important as the further coating needs to be the outermost surface of the ultimate casting and is provided by transferring the further coating and the bond coating from the core and/or mould to the casting piece during the casting process, rather than subsequently. In this context, the outermost surface is the surface finish, whether external surface finish or internal surface finish, of the casting. As such, the outermost surface can be provided on an interior and/or exterior surface of the casting, it being appreciated that even an internal surface has an outermost layer, i.e. the surface layer or surface finish. The further coating is intended to protect the casting, whether that is thermal protection or protection from fouling for example, so it needs to be provided in a location where it can serve its desired function. This allows the further coating to be easily and reliably provided on the casting, particularly an interior surface of the casting, whereas existing methods required that any surface coating be provided after removal from the mould, and providing a reliable and uniform surface coating was time-consuming and difficult, particularly in relation to interior surfaces where it was not possible to provide uniform and reliable coatings on such interior surfaces.

Providing a coated mould element may include providing a sand-based mould element having a water-based coating. Water-based coatings are able to improve the surface finish of the ultimate casting.

The further coating and the bond coating may be provided via spraying, such as thermal spraying, and/or dipping.

The further coating may be a coating selected from a thermal barrier coating, an anti-corrosion coating, a friction-reducing coating, an oleophobic coating, a hydrogen-embrittlement protection coating, an anti-oxidation coating, an anti-erosion coating, or an anti-fouling coating. Thermal barrier coatings serve to reduce the transmission of thermal energy. In an example, where the thermal barrier coating is applied to an interior surface of a housing of a turbomachine, the thermal barrier coating reduces the amount of thermal energy lost from exhaust gases passing therethrough. Since less energy is lost, there is more energy available to drive the turbine and consequently the compressor. Previously, coating the interior passage of a turbine housing with a thermal barrier coating has not been possible since the materials are applied by thermal spraying and it is not possible to ensure a consistent and uniform coating of an internal surface which is stable using such a technique. Fuel cells may utilise a turbine. Such fuel cells may utilise a fuel, such as hydrogen or hydrocarbon gas, which are usually at low temperatures. As such, whilst high temperatures may not be an issue, certain materials are susceptible to hydrogen embrittlement, so the coating may be selected to protect underlying material from embrittlement.

The mould element may be in the shape of an internal passage of a turbomachine. Turbochargers, a particular type of turbomachine, utilise exhaust gases to drive a turbine which in turn drives a compressor, which then feeds compressed gas into an engine. The internal passages are shaped to maximise efficiency within dimensional limits and are consequently relatively complex shapes. Such complex shapes do not allow for easy and reliable application of internal coatings and the present disclosure allows for such internal coatings to be applied. The present invention also allows for the provision of functional coatings on the external surface of a casting.

According to a second aspect of the present disclosure, there is provided a method of casting a housing for a turbomachine having an internal coating, the method including: a) providing a multi-layered core having a central core, a core coating, a further coating, and a bond coating in said order; b) providing a casting mould including the multi-layered core, said casting mould and multi-layered core defining a cavity; c) introducing molten metal into the cavity; and d) allowing the molten metal to solidify in the cavity to form a housing casting intermediary.

The method according to the second aspect of the present disclosure provides a method for providing an internal coating on a housing for a turbomachine. This is achieved by providing a multi-layered core with coatings in a pre-determined order such that when liquid metal is introduced, it is able to form a bond with the bond coating, which in turn is bonded to a further coating, which becomes the surface of the casting intermediary once removed from the mould.

The method may further include removing the central core and the core coating thereby leaving the bond coating and further coating on the surface of the housing casting intermediary. The casting intermediary may be subsequently machined further to provide a finished casting.

The further coating may be selected from a thermal barrier coating, an anti-corrosion coating, a friction-reducing coating, an oleophobic coating, a hydrogen embrittlement protection coating, an anti-oxidation coating, an anti-erosion coating, or an anti-fouling coating. The further coating is preferably a thermal barrier coating.

According to a third aspect of the present disclosure, there is provided a mould element for use in casting metal, the mould element including: a) a central mould element, b) a mould element coating on the central mould element, c) a further coating on the mould element coating; and d) a bond coating on the further coating.

As will be appreciated and as with the other aspects of the present disclosure, the mould element may be a mould core. The core may be a separate core, that is to say that the core is a separate element to the rest of the mould, or could be an integral core, which is where the core is effectively integral with the rest of the mould.

The mould element coating may be a water-based mould element coating.

The bond coating may include iron. This is particularly advantageous where the bulk of the casting is a ferrous metal, such that the bond coating shares a common metal, namely iron, to provide a robust connection between the casting and the bond coating. Where the bulk of the casting is a material other than iron, such as aluminium, the bond coating preferably include the same material, such as aluminium. By having the same material in the bulk of the casting and in the bond coating, a stronger bond is formed. As such the bond coating may include a material which forms the majority of the bulk of the casting.

As with the other aspects of the present disclosure, the further coating of the mould element may be selected from a thermal barrier coating, an anti-corrosion coating, a friction-reducing coating, an oleophobic coating, a hydrogen embrittlement protection coating, an anti-oxidation coating, an anti-erosion coating, or an anti-fouling coating.

According to a fourth aspect of the present disclosure, there is provided a mould for producing a housing of a turbomachine, the mould including a mould element according to the third aspect of the present disclosure.

According to a fifth aspect of the present disclosure, there is provided a housing for a turbomachine, the housing including an internal volute surface, wherein the internal volute surface includes a barrier coating bonded to the internal volute surface of the housing via a bond coating.

As described in respect of the other aspects of the present disclosure, it has not previously been possible to provide an adequate barrier coating, whether a thermal barrier coating, an anti-corrosion coating, a friction-reducing coating, an oleophobic coating, a hydrogen embrittlement protection coating, an anti-oxidation coating, an anti-erosion coating, or an anti-fouling coating, on the internal volute of a turbomachine housing due to the difficulties in ensuring a uniform application of such a barrier coating within an inner surface of a casting.

According to a sixth aspect of the present disclosure, there is provided a turbine housing manufactured according to the process or method according to the first or second aspects of the present disclosure.

It will be appreciated that features described in respect of one aspect of the present disclosure are equally applicable to any other aspect of the present disclosure, except where such features are mutually incompatible. As such, all features describing one aspect of the present invention equally apply to any other aspect of the present invention.

It will be appreciated that where appropriate any of the above aspects may incorporate one or more features of any of the other aspects.

### BRIEF DESCRIPTION OF THE DRAWINGS

Embodiments of the invention will now be described, by way of example only, with reference to the accompanying drawings, of which:

FIG. 1 depicts one way in which a core may be formed in accordance with the first aspect of the present disclosure;

FIG. 2 depicts a casting intermediary being produced according to aspects of the present disclosure;

FIG. 3 depicts a cross-section of a casting intermediary before the sand core has been removed; and

FIGS. 4a, 4b and 4c depict a cross-section of a prior art casting with a thermal barrier coating applied directly to the casting, and images of a failed casting which did not include a bond coating between the thermal barrier coating and the casting metal.

### DETAILED DESCRIPTION OF EMBODIMENTS

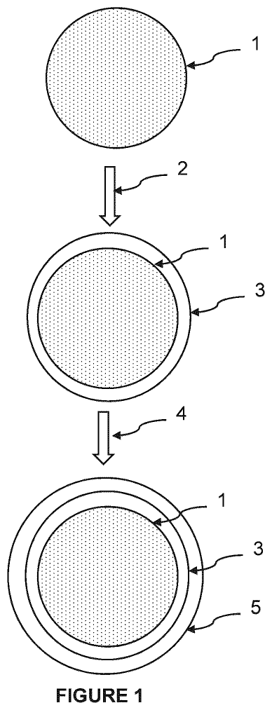

FIG. 1 depicts a mould element in the form of a sand core 1. It will be appreciated that alternative casting core materials, such as salt, may be used and that the present disclosure is not particularly limited to the exact core material used. The sand core 1 forms the central core of the ultimate coated central core and the shape of the final casting. The core 1 can be a separate piece to the mould in which the casting is formed, or could be an integral portion of the mould. The core 1 includes a core coating 1′ (not shown) that is configured to prevent the further coating, which may be a barrier coating such as a thermal barrier coating, an anti-corrosion coating, a friction-reducing coating, an oleophobic coating, a hydrogen-embrittlement protection coating, an anti-oxidation coating, an anti-erosion coating, or an anti-fouling coating, from being rough or patchy due to partial penetration into the material comprising the core, which may be sand. In process step 2, a further coating 3 is provided on the coated central core 1. The further coating 3 is a coating of material which is additional to the coating provided on the central core material. The further coating 3 is the material which will become the outer surface of the final casting. In other words, the further coating 3 will be the surface finish or surface material of the casting, whether it is the surface material of an interior face of the casting or the surface of an exterior face of the casting. In some embodiments, the further coating 3 is a thermal barrier coating, which is configured to reduce the rate at which thermal energy is transmitted therethrough. Where the casting is a housing of a turbomachine, the thermal barrier coating serves to retain thermal energy within exhaust gases flowing therethrough such that a greater amount of energy is able to reach the turbine. In process step 4, a bond coating 5 is provided on the further coating 3. The bond coating 5 is a different composition to the further coating 3 and is configured to provide improved bonding between the further coating 3 and the metal of the casting. Without a bond coating, it has been found that the further coating only poorly adheres to the casting metal, if at all. This makes it unsuitable for use in practice, particularly in cases where any material which detaches from the casting metal can cause downstream damage, such as to a turbine in a turbomachine.

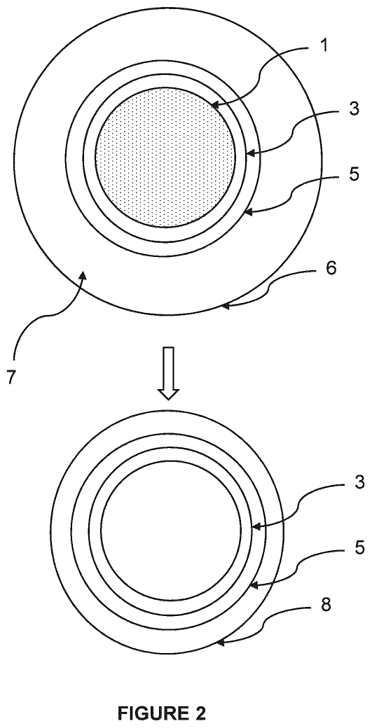

FIG. 2 depicts the multi-layered core of FIG. 1 disposed within a mould 6. The core and the mould 6 together at least partially define a cavity 7 into which molten metal, which may be ferrous, may be poured. When a casting is being prepared, molten metal is provided into the cavity 7 and allowed to solidify in the cavity 7 to form a casting intermediary. The core and mould materials may then be removed to leave a casting. The casting includes the further coating 3, the bond coating 5, and the solidified metal casting 8. In the depicted examples, the core, mould, and ultimate casting are shown as circular for the sake of clarity, but the exact shape of these elements will depend on the desired shape of the final casting.

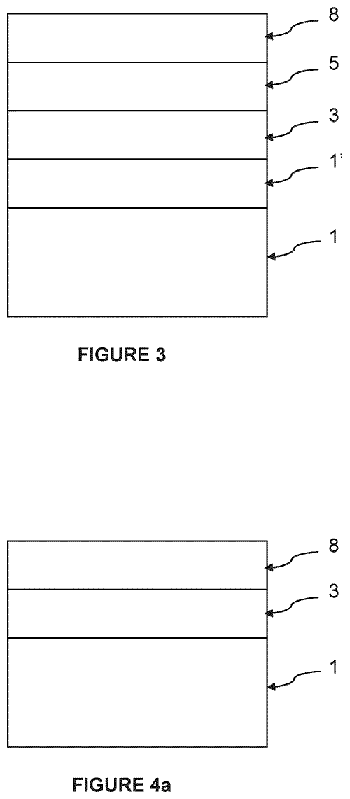

FIG. 3 depicts a cross-section through a casting intermediary according to the present disclosure. As can be seen, the stack comprises, in order, a sand core 1, a core coating 1′, a further coating 3, a bond coating 5, and solidified metal casting 8.

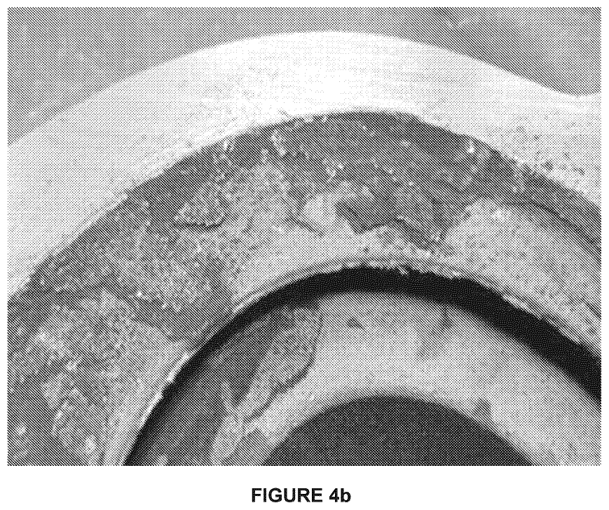

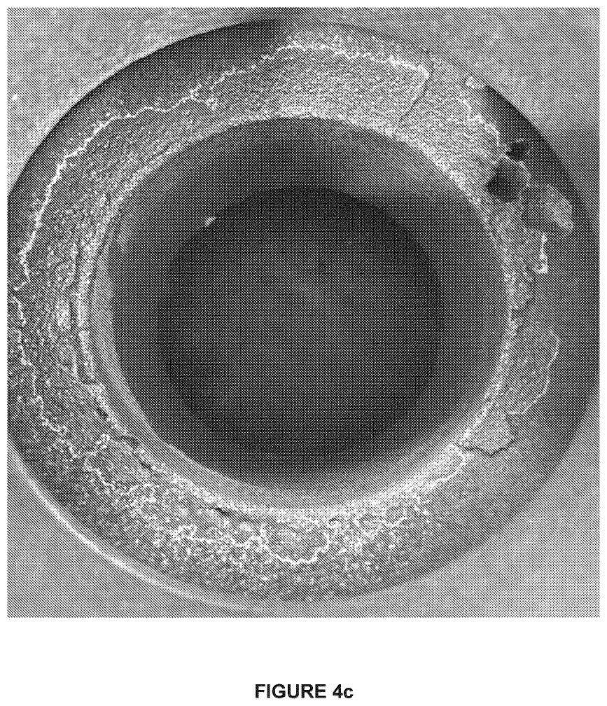

FIG. 4a depicts a cross-section through a prior art casting intermediary. The stack comprises, in order a sand core 1, a thermal barrier coating 3, and a solidified metal casting 8. There is no bond coating disposed between the thermal barrier coating 3 and the metal casting 8, neither is there a core coating 1′ on the core 1.

FIG. 4b is an image of a thermal barrier coating which had been applied via a sand core to a turbine housing volute surface without the use of a core coating or a bond coating. The thermal barrier coating is rough, discontinuous, and failed to bond to the metal of the turbine housing volute.

FIG. 4c is an image of a turbine housing volute which was produced including a bond coating, but not using a core coating. As can be seen, whilst the thermal barrier coating was better able to adhere to the turbine housing volute surface, there were numerous casting defects and blowholes, which made it unusable.

The present disclosure provides methods and means for providing a functional coating on castings, and particularly to castings which have a complex internal geometry, such as volutes of turbine housings of turbochargers. The present disclosure also provides for providing a functional coating on internal and/or external surfaces of a casting. The present disclosure allows for the provision of coatings which are strongly bonded to the casting and are uniform. This is achieved by provision of a coated mould element, which may be a coated mould core or a cope or drag or equivalent, as well as a bond coating, neither of which is realised in the prior art.

1. A process of forming a mould for casting metal, the process including:
a) providing a coated mould element;
b) providing a further coating on the coated central mould element; and
c) providing a bond coating on the further coating.

2. The process according to claim 1, wherein providing a coated mould element includes providing a sand-based mould element having a water-based core coating.

3. The process according to claim 1, wherein one or both of the further coating and the bond coating are provided via thermal spraying and/or dipping.

4. The process according to claim 1, wherein the further coating is a coating selected from a thermal barrier coating, an anti-corrosion coating, a friction-reducing coating, an oleophobic coating, a hydrogen-embrittlement protection coating, an anti-oxidation coating, an anti-erosion coating, and an anti-fouling coating.

5. The process according to claim 1, wherein the mould element is a central core.

6. The process according to claim 1, wherein the mould element is in the shape of an internal passage of a turbomachine, optionally in the shape of an internal volute of a turbine housing of a turbomachine.

7. A method of casting a housing for a turbomachine having an internal coating, the method including:
a) providing a multi-layered core having a central core, a core coating, a further coating, and a bond coating in said order;
b) providing a casting mould including the multi-layered core, said casting mould and multi-layered core defining a cavity;
c) introducing molten metal into the cavity; and
d) allowing the molten metal to solidify in the cavity to form a housing casting intermediary.

8. The method according to claim 7, wherein the further coating is selected from a thermal barrier coating, an anti-corrosion coating, a friction-reducing coating, an oleophobic coating an anti-oxidation coating, an anti-erosion coating, a hydrogen-embrittlement protection coating, or an anti-fouling coating.

9. The method according to claim 7, wherein the method further includes removing the central core and the core coating thereby leaving the bond coating and further coating on the surface of the housing casting intermediary.

10. A mould element for use in casting metal, the mould element including:
a) a central mould element
b) a mould element coating on the central mould element
c) a further coating on the mould element coating; and
d) a bond coating on the further coating.

11. The mould element according to claim 10, wherein the mould element coating is a water-based mould element coating.

12. The mould element according to claim 10, wherein the bond coating includes a metal which forms the bulk of the intended casting material, preferably iron or aluminium.

13. The mould element according to claim 10, wherein the further coating is selected from a thermal barrier coating, an anti-corrosion coating, a friction-reducing coating, an oleophobic coating, a hydrogen embrittlement protection coating, an anti-oxidation coating, an anti-erosion coating, or an anti-fouling coating

14. The mould element according to claim 10, wherein the mould element is a core.

15. The mould for producing a housing of a turbomachine, the mould including a mould element according to claim 10.

16. A housing for a turbomachine, the housing including an internal volute surface, wherein the internal volute surface includes a barrier coating bonded to the internal volute surface of the housing via a bond coating.

17. The housing for a turbomachine according to claim 16, wherein the barrier coating is selected from a thermal barrier coating, an anti-corrosion coating, a friction-reducing coating, an oleophobic coating, a hydrogen embrittlement protection coating, an anti-oxidation coating, an anti-erosion coating, or an anti-fouling coating.

18. A turbine housing manufactured according to claim 1.
